(19) United States
(12) Patent Application Publication
(10) Pub. No.: US 2015/0014133 A1
(43) Pub. Date: Jan. 15, 2015

(54) SWITCH ASSEMBLY

(71) Applicants: HON HAI PRECISION INDUSTRY CO., LTD., New Taipei (TW); HONG FU JIN PRECISION INDUSTRY (ShenZhen CO., LTD., Shenzhen (CN)

(72) Inventors: LI-REN FU, Shenzhen (CN); WAN-LI NING, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/972,899

(22) Filed: Aug. 21, 2013

(30) Foreign Application Priority Data
Jul. 11, 2013 (CN) 2013102898749

(51) Int. Cl. H01H 13/02; H01H 13/04

(52) U.S. Cl. CPC H01H 13/023; H01H 13/04
USPC 200/317

(57) ABSTRACT

A switch assembly mounted to a circuit board includes a switch and a housing. A light-emitting diode (LED) is mounted on the circuit board. The switch is received in the housing. The housing is mounted on the circuit board and covers the LED.

### BACKGROUND

1. Technical Field

The present disclosure relates to a switch assembly.

2. Description of Related Art

Light-emitting diodes (LEDs) are often mounted on circuit boards to show operation states of electronic elements mounted on the circuit boards. However, light emitted by LEDs often reflects off surfaces of other LEDs. As a result, it is difficult for a user to clearly see the operation state of electronic elements.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a switch assembly, together with a circuit board.

FIG. 2 is an enlarged, inverted view of the switch assembly of FIG. 1.

FIG. 3 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

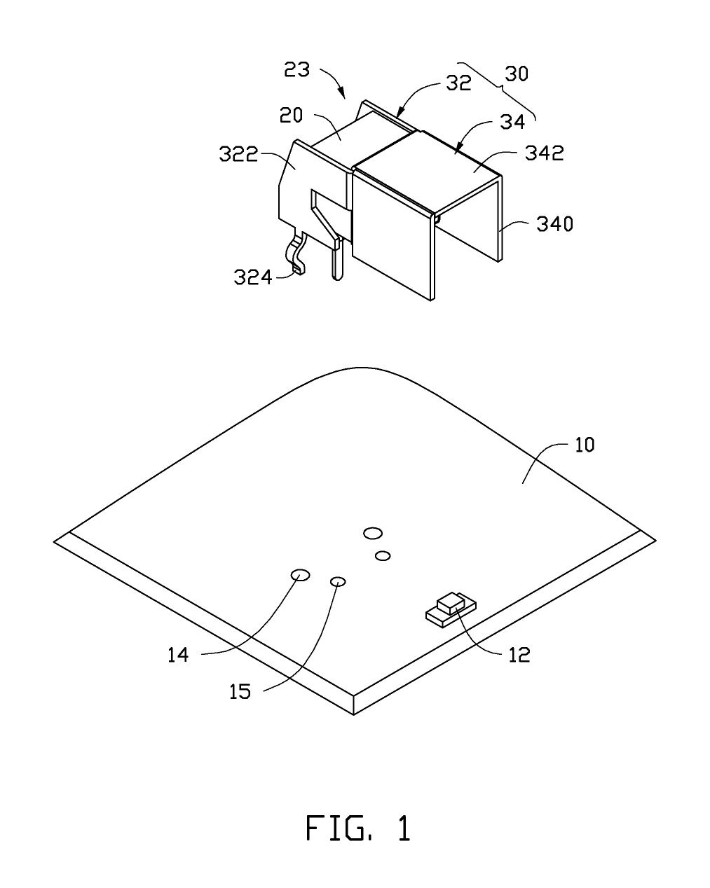

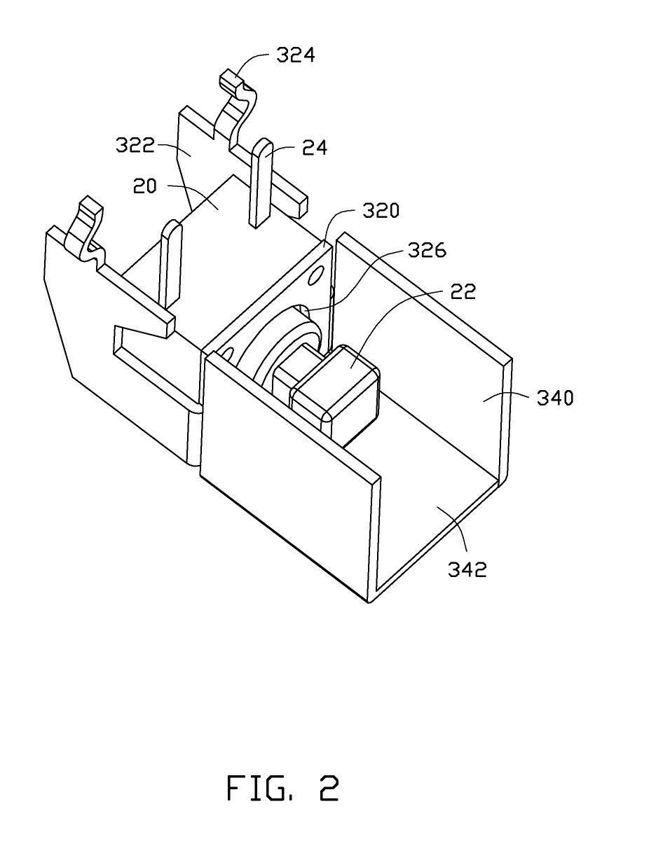

Referring to FIGS. 1 and 2, an embodiment of a switch assembly 23 is mounted on a circuit board 10. The switch assembly 23 includes a switch 20 and a housing 30.

The circuit board 10 includes an LED 12 mounted on a top surface. The LED 12 shows an operation state of an electronic element (not shown) mounted on the circuit board 10. The circuit board 10 defines two fixing holes 14 and two receiving holes 15 adjacent to the LED 12.

The switch 20 controls the electronic element. A button 22 protrudes from a front side of the switch 20. Two pins 24 perpendicularly extend from a bottom of the switch 20.

The housing 30 includes a fixing portion 32 and a covering portion 34 connected to the fixing portion 32.

The fixing portion 32 includes a connecting piece 320 substantially perpendicular to the circuit board 10. The fixing portion 32 defines a through hole 326, two extension pieces 322 extending substantially perpendicularly rearward from opposite sides of the connecting piece 320. Two legs 324 extending down from bottoms of the extension pieces 322.

The covering portion 34 includes a top wall 342 substantially perpendicularly extending forward from a top side of the connecting piece 320, and two sidewalls 340 substantially perpendicularly extending down from opposite sides of the top wall 342.

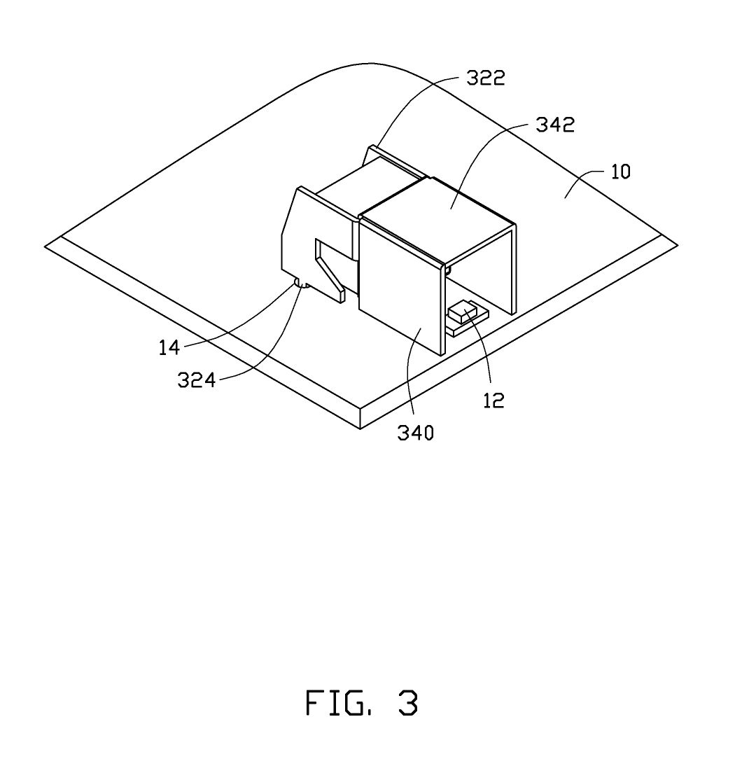

Referring to FIG. 3, in assembly, the switch 20 is received in the fixing portion 32, and is limited by the connecting piece 320 and the extension pieces 322. The button 22 extends out of the fixing portion 32 and through the through hole 326 to enter into the covering portion 34. The pins 24 are electrically inserted into the receiving holes 15. The legs 324 are engaged in the fixing holes 14. The covering portion 34 encloses the LED 12. Bottoms of the sidewalls 340 contact the circuit board 10, thereby preventing light emitted by other LEDs from reflecting off surfaces of the LED 12.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A switch assembly mounted to a circuit board with a light-emitting diode (LED), the switch assembly comprising a switch and a housing receiving the switch, wherein the housing is to be mounted on the circuit board and covers the LED.

2. The switch assembly of claim 1, wherein the housing comprises a fixing portion receiving the switch and a covering portion connected to the fixing portion to cover the LED.

3. The switch assembly of claim 2, wherein the fixing portion comprises a connecting piece substantially perpendicular to the circuit board and two extension pieces perpendicularly extending from the connecting piece.

4. The switch assembly of claim 3, wherein the connecting piece defines a through hole, the switch comprises a button extending through the through hole.

5. The switch assembly of claim 2, wherein the covering portion comprises a top wall perpendicularly extending out from the fixing portion and two sidewalls extending down from opposite sides of the top wall to contact the circuit board.
